(19) United States
(12) Patent Application Publication
(10) Pub. No.: US 2026/0182569 A1
(43) Pub. Date: Jul. 2, 2026

(54) SMART BIOSTIMULANT DELIVERY FOR PLANT GROWTH AND DEVELOPMENT

(71) Applicant: King Abdullah University of Science and Technology, Thuwal (SA)

(72) Inventors: Nivine KHACHAB, Thuwal (SA); Salim AL-BABILI, Thuwal (SA)

(21) Appl. No.: 19/125,965

(22) PCT Filed: Nov. 6, 2023
(86) PCT No.: PCT/IB2023/061185

§ 371 Date: Apr. 30, 2025

Related U.S. Application Data
(60) Provisional application No. 63/423,248, filed on Nov. 7, 2022.
(60) Provisional application No. 63/530,384, filed on Aug. 2, 2023.

(51) Int. Cl. A01N 35/02; A01G 7/00; A01N 25/08; A01P 21/00

(52) U.S. Cl. CPC A01N 35/02; A01G 7/00; A01N 25/08; A01P 21/00

(57) ABSTRACT

A plant treatment composition includes a biostimulant and a coordination-based platform including a metal, wherein the biostimulant is encapsulated in the coordination-based platform and the metal interacts with the biostimulant. A method of promoting plant growth includes applying to a seed, plant propagation material, or plant, a composition including a biostimulant, and a coordination-based platform, wherein the biostimulant is encapsulated in the coordination-based platform and the composition is sufficient to improve plant yield.

### CROSS-REFERENCE TO RELATED APPLICATIONS

This application claims benefit of U.S. Provisional Application No. 63/423,248, filed on Nov. 7, 2022, and U.S. Provisional Application No. 63/530,384, filed on Aug. 2, 2023. U.S. Provisional Application No. 63/423,248 and U.S. Provisional Application No. 63/530,384 are incorporated herein by reference, and a claim of priority is made.

### BACKGROUND

Precision agriculture, in terms of the controlled delivery of bioactive molecules to plants, is a recently emerging field to stimulate stress tolerance and enhance yield and resistance to pathogens found in the environment. Crops grown under hot and extreme climatic conditions in poor-quality soil require fertilizer and growth promoter applications to increase production with minimal impacts on microbial life and water resources. Consequently, the release of such agrichemicals mainly occurs by capsule erosion or passive diffusion resulting in poor control over efficiency and delivery. Hence, there is a clear demand to develop smart platforms for precise and controlled delivery of agrichemicals.

### SUMMARY

According to one aspect, a plant treatment composition includes a biostimulant and a coordination-based platform including a metal, wherein the biostimulant is encapsulated in the coordination-based platform and the metal interacts with the biostimulant.

According to another aspect, a method of synthesizing nanoparticles includes contacting one or more of an imidazole and a polyphenol with a biostimulant to form a first solution, contacting the first solution with a metal salt sufficient to form a second solution, and separating the second solution sufficient to obtain formed nanoparticles, wherein the formed nanoparticles include the biostimulant encapsulated in a coordination-based platform.

According to another aspect, a method of promoting plant growth includes applying to a seed, plant propagation material, or plant, a composition including: a biostimulant and a coordination-based platform, wherein the biostimulant is encapsulated in the coordination-based platform and the composition is sufficient to improve plant yield.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates a method 100 of synthesizing nanoparticles, according to some embodiments.

FIG. 2 illustrates a method 200 of promoting plant growth, according to some embodiments.

FIG. 3 illustrates a method 300 of synthesizing nanoparticles, according to some embodiments.

FIG. 4 illustrates a schematic illustration of the “one-pot” synthesis of the zeolitic imidazolate framework ZIF-8@MiZax-3 complex, according to some embodiments.

FIG. 5A illustrates a schematic representation of ZIF-8@MiZax-3 synthesis, according to some embodiments.

FIG. 5B illustrates a transmission electron microscopy (TEM) image of ZIF-8@MiZax-3 at 500 and 100 nm scale showing the hexagonal structure of the framework, according to some embodiments.

FIG. 5C illustrates PXRD patterns of ZIF-8, MiZax-3, and the synthesized ZIF-8@MiZax-3, according to some embodiments.

FIG. 5D illustrates a comparison of the UV-vis absorption spectra of ZIF-8, MiZax-3, and the synthesized ZIF-8@MiZax-3, according to some embodiments.

FIG. 5E illustrates thermo-gravimetric analysis (TGA) of ZIF-8, MiZax-3, and ZIF-8@MiZax-3 powder under N₂, according to some embodiments.

FIG. 5F illustrates a cumulative release of MiZax-3 from the platform at acidic (pH 6) and neutral (pH 7) conditions, according to some embodiments.

FIG. 6A illustrates the particle size distribution of the ZIF-8@MiZax-3 complex, according to some embodiments.

FIG. 6B illustrates the particle size distribution of the ZIF-8 complex, according to some embodiments.

FIG. 7 illustrates a comparison of the FTIR spectra of MiZax-3, ZIF-8, and ZIF-8@MiZax-3, according to some embodiments.

FIG. 8 illustrates the standard plot of MiZax-3 solution in chloroform at different concentrations, according to some embodiments.

FIG. 9A illustrates UV-vis spectra demonstrating the thermal stability of MiZax-3 in aqueous solutions prepared with several components of the soil organic matter after 24 hours of treatment at 45° C., according to some embodiments.

FIG. 9B illustrates UV-vis spectra demonstrating the thermal stability of ZIF-8@MiZax-3 in aqueous solutions prepared with several components of the soil organic matter after 24 hours of treatment at 45° C., according to some embodiments.

FIG. 9C illustrates LC-MS quantification of the remaining MiZax-3 in dry powder form after incubation at 45° C. for 30 days, according to some embodiments.

FIG. 10A illustrates a cytotoxicity analysis of precursor molecules, including Zn(NO₃)₂, 2-methylimidazole (2-MIm), and MiZax-3, according to some embodiments.

FIG. 10B illustrates a cytotoxicity analysis of ZIF-8 and ZIF-8@MiZax-3 complexes, according to some embodiments.

FIG. 10C illustrates a schematic representation of the final product utilized for soil treatment, according to some embodiments.

FIG. 10D illustrates pictures of a field experiment utilizing ZIF-8@MiZax-3, according to some embodiments.

FIG. 11A illustrates representative images taken from the capsicum field trials at the final stage of development (13 weeks after transplanting WAT), according to some embodiments.

FIG. 11B illustrates a graph of the number of buds per individual at 4WAT, according to some embodiments.

FIG. 11C illustrates a graph of the plant height measurements recorded at 4WAT, 6WAT and 8WAT, according to some embodiments.

FIG. 11D illustrates a graph of the average dry biomass of an individual plant per lane at 13WAT, according to some embodiments.

FIG. 11E illustrates a graph of the zinc content analysis of capsicum fruits across treatments, according to some embodiments.

FIG. 11F illustrates a spider-web diagram summarizing the findings in capsicum field trial demonstrating the overall superiority of ZIF-8@MiZax-3 over other treatments and mock, according to some embodiments.

FIG. 12A illustrates fresh biomass analysis of tomato seedlings treated with ZIF-8, MiZax-3 (5 μM), ZIF-8@MiZax-3, according to some embodiments.

FIG. 12B illustrates fresh biomass analysis of pearl millet seedlings treated with ZIF-8, MiZax-3 (5 μM), ZIF-8@MiZax-3, according to some embodiments.

### DETAILED DESCRIPTION

Embodiments of the present disclosure describe a novel approach to incorporate biostimulants into coordination-based platforms. To ensure food security to an increasing human population, agri-food systems must become more sustainable by reducing the use of fertilizers and pesticides. The novel complexes of the present disclosure increase growth and yield of many plants with no cytotoxic effects. Further, these complexes provide valuable nutrients released during the platform degradation process and can efficiently and controllably release biostimulants.

A plant treatment composition may include one or more of a biostimulant, nutrient, phosphate, and a coordination-based platform. The biostimulant, nutrient, and/or phosphate is encapsulated in the coordination-based platform sufficient to improve plant yield. In one example, the coordination-based platform includes a metal, wherein the metal interacts with the biostimulant, nutrient, and/or phosphate. A metal in the coordination-based platform can interact with the biostimulant by coordinating with the electron rich atoms which improves the loading capacity and controls the release. For example, a zinc metal in the coordination-based platform can interact with the biostimulant sufficient to further increase plant yield. The plant treatment composition may further include phosphorus.

In one example, the biostimulant is an apocarotenoid. For example, the biostimulant may be a cleavage product of carotenoids. The biostimulant may be a natural or synthetic apocarotenoid. In another example, the biostimulant includes natural and/or synthetic Zaxinone. For example, the synthetic Zaxinone may include one or more of MiZax-1, MiZax-2, MiZax-3, MiZax-4, and MiZax-5. The biostimulant may be sufficient to improve root growth, increase root diameter, increase soil water holding capacity, and increase nutrient availability and nutrient use efficiency. The biostimulant may be sufficient to improve stress tolerance in a plant and increase the weight of biomass per plant.

The coordination-based platform may include a zeolitic imidazolate framework (ZIF). In one example, the coordination-based platform may include a metal such as calcium, iron, magnesium, and zinc. The coordination-based platform may include two or more of calcium, iron, magnesium, and zinc. The composition may include a plurality of nanoparticles. In one example, the nanoparticles have a diameter ranging from about 20 nm to about 300 nm. In another example, the nanoparticles have a diameter ranging from about 80 nm to about 200 nm. In yet another example, the nanoparticles have a diameter ranging from about 100 nm to 150 nm.

Importantly, encapsulating the biostimulant in the coordination-based platform improves stability of the biostimulant and decreases the rate of degradation by the environment. In one example, encapsulation of the biostimulant in the coordination-based platform includes enclosing the biostimulant within the coordination-based platform. Since most plants utilize soil as substrates, the temperature, water content, and pH play a key role in the degradation process. Further, crops grown in hot conditions normally require fertilizer and growth promoter—each of which have poor efficiency control. Without proper encapsulation, the biostimulant would be less stable under these conditions. In contrast, the composition of the present disclosure may keep the biostimulant stable in soil for over 30 days at high temperatures. In one example, the encapsulated biostimulant may be over 500 times more stable than a non-encapsulated biostimulant.

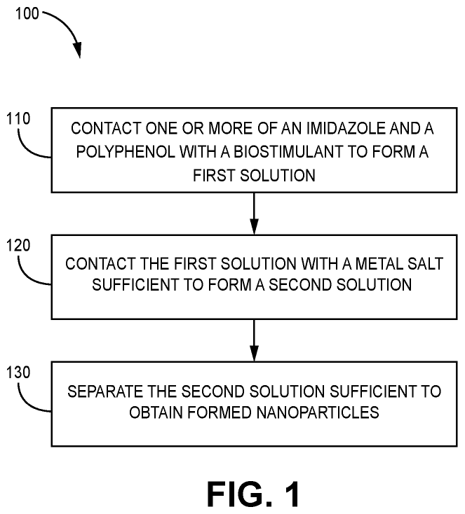

Referring to FIG. 1, a method 100 of synthesizing nanoparticles is illustrated according to some embodiments. The method 100 includes the following steps:

STEP 110, CONTACT ONE OR MORE OF AN IMIDAZOLE AND A POLYPHENOL WITH A BIOSTIMULANT TO FORM A FIRST SOLUTION, includes contacting, such as mixing, one or more of an imidazole, such as 2-methylimidazole, and a polyphenol with a biostimulant, such as Zaxinone, to form a first solution. Additionally, or alternatively, STEP 110 may include contacting an imidazole with one or more of a biostimulant, plant nutrients, and phosphates. The plant nutrients are sufficient to improve the yield of agricultural crops. Contacting may include placing two or more components in physical contact, mixing, stirring, heating, and/or cooling. In one example, the imidazole is 2-methylimidazole. For example, 2-methylimidazole with a concentration ranging from 0.5 M to 4 M may be utilized. In another example, 2-methylimidazole with a concentration of about 2.5 M may be utilized.

In one example, the biostimulant is an apocarotenoid. For example, the biostimulant may be a cleavage product of carotenoids. The biostimulant may be a natural or synthetic apocarotenoid. In another example, the biostimulant includes natural and/or synthetic Zaxinone. For example, the synthetic (or mimic) Zaxinone may include one or more of MiZax-1, MiZax-2, MiZax-3, MiZax-4, and MiZax-5 (all shown in Example 1). In one example, MiZax with a concentration ranging from 1 mM to 150 mM in an alcohol may be utilized. In another example, MiZax with a concentration of about 40 mM in an alcohol may be utilized. Zaxinone is a carotenoid-derived regulatory metabolite that promotes plant growth. The biostimulant may be a biostimulant sufficient for increasing the yield of a plant. In one example, increasing the yield of a plant includes one or more of increasing the plant height, increasing the number of buds, increasing the number of fruits formed, and increasing the size of the plant and/or fruit. The biostimulant may be sufficient to improve root growth, increase root diameter, increase soil water holding capacity, and increase nutrient availability and nutrient use efficiency. The biostimulant may be sufficient to improve stress tolerance in a plant and increase the weight of biomass per plant.

STEP 120, CONTACT THE FIRST SOLUTION WITH A METAL SALT SUFFICIENT TO FORM A SECOND SOLUTION, includes contacting the first solution with a metal salt, such as zinc nitrate hexahydrate, sufficient to form a second solution. STEP 120 may be completed at the same time as STEP 110 in order to contact the metal salt, biostimulant, and one or more of imidazole and polyphenol at the same time. Contacting may include placing two or more components in physical contact, mixing, stirring, heating, and/or cooling. In one example, the metal salt includes one or more of calcium, copper, iron, magnesium, and zinc. In another example, the metal salt includes a metal nitrate. For example, the metal salt may include zinc nitrate hexahydrate. In one example, zinc nitrate hexahydrate with a concentration ranging from 0.1 M to 1 M may be utilized. Zinc nitrate hexahydrate with a concentration of about 0.5 M may be utilized. Phosphorous may also be added to the first or second solution.

STEP 130, SEPARATE THE SECOND SOLUTION SUFFICIENT TO OBTAIN FORMED NANOPARTICLES, includes separating the second solution sufficient to obtain formed nanoparticles, wherein the formed nanoparticles include the biostimulant encapsulated in a coordination-based platform. Separating may include spinning one or more of the second solution and the formed nanoparticles. For example, separating may include using a centrifuge at a sufficient speed setting to separate/obtain the formed nanoparticles. In one example, a centrifuge may be operated at 2000-8000 RPM for 1 minute to 30 minutes. In another example, a centrifuge may be operated at 7000 RPM for 5 minutes to 15 minutes. The separation process may be sufficient to recover pellets. Pellets may be dried in a vacuum desiccator. Pellets may be ground to obtain a fine powder of nanoparticles.

In one example, the formed nanoparticles have a diameter ranging from about 20 nm to about 300 nm. In another example, the formed nanoparticles have a diameter ranging from about 80 nm to about 200 nm. In yet another example, the formed nanoparticles have a diameter ranging from about 100 nm to 150 nm. The formed nanoparticles include the biostimulant encapsulated in a coordination-based platform. In one example, the loading efficiency of the biostimulant in the coordination-based platform may be greater than 60%. The coordination-based platform may include a zeolitic imidazolate framework (ZIF). A metal in the coordination-based platform can interact with the biostimulant by coordinating with the electron rich atoms which improves the loading capacity and controls the release. For example, a zinc metal in the coordination-based platform can interact with the biostimulant sufficient to further increase plant yield.

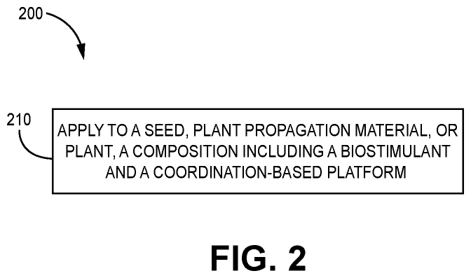

Referring to FIG. 2, a method 200 of promoting plant growth is illustrated according to some embodiments. The method 200 includes the following steps:

STEP 210, APPLY TO A SEED, PLANT PROPAGATION MATERIAL, OR PLANT, A COMPOSITION INCLUDING A BIOSTIMULANT AND A COORDINATION-BASED PLATFORM, includes applying to a seed, plant propagation material, or plant, such as roots or soil, a composition including a biostimulant and a coordination-based platform. The biostimulant is encapsulated in the coordination-based platform sufficient to improve plant yield. The composition may further include plant nutrients, phosphates, and phosphorus.

In one example, the seed, plant propagation material, or plant may be selected from the Brassicaceae family, the Chenopodiaceae family, the Poaceae family, the Fabaceae family, the Compositae family, the Cucurbitaceae family, the Convolvulaceae family, the Solanaceae family, the Amaryllidaceae family, and the Umbelliferae family. In another example, the seed, plant propagation material, or plant may be selected from the Capsicum genus, the Solanum genus, the Cenchrus genus, and the Zea genus. For example, the seed, plant propagation material, or plant may be selected from a tomato plant, a pearl millet plant, and a pepper plant.

In one example, the biostimulant is an apocarotenoid. For example, the biostimulant may be a cleavage product of carotenoids. The biostimulant may be a natural or synthetic apocarotenoid. In another example, the biostimulant includes natural and/or synthetic Zaxinone. For example, the synthetic Zaxinone may include one or more of MiZax-1, MiZax-2, MiZax-3, MiZax-4, and MiZax-5. The biostimulant may be a biostimulant sufficient for increasing the yield of a plant. In one example, increasing the yield of a plant includes one or more of increasing the plant height, increasing the number of buds, increasing the number of fruits formed, increasing the size of the plant and/or fruit. The biostimulant may be sufficient to improve root growth, increase root diameter, increase soil water holding capacity, and increase nutrient availability and nutrient use efficiency. The biostimulant may be sufficient to improve stress tolerance in a plant and increase the weight of biomass per plant.

The coordination-based platform may include a zeolitic imidazolate framework. In one example, the coordination-based platform may include a metal such as calcium, iron, magnesium, and zinc. A metal in the coordination-based platform can interact with the biostimulant. For example, a zinc metal in the coordination-based platform can interact with the biostimulant sufficient to further increase plant yield. The composition may include a plurality of nanoparticles. In one example, the nanoparticles have a diameter ranging from about 20 nm to about 300 nm. In another example, the nanoparticles have a diameter ranging from about 80 nm to about 200 nm. In yet another example, the nanoparticles have a diameter ranging from about 100 nm to 150 nm.

As mentioned, encapsulating the biostimulant in the coordination-based platform improves stability of the biostimulant and decreases the rate of degradation by the environment. Since most plants utilize soil as substrates, the temperature, water content, and pH play a key role in the degradation process. Further, crops grown in hot conditions normally require fertilizer and growth promoter—each of which have poor efficiency control. Without proper encapsulation, the biostimulant would be less stable under these conditions. In contrast, the composition of the present disclosure may keep the biostimulant stable in soil for over 30 days at high temperatures. In one example, the encapsulated biostimulant may be over 500 times more stable than a non-encapsulated biostimulant. The encapsulated biostimulant composition may decrease the impact of environmental stresses for a plant. Environmental stresses may include high and low temperatures, low soil water content, droughts, acidic soils, low soil nutrient content, and lower than average hours of sunlight.

The encapsulation efficiently controls the amount of biostimulant released sufficient to improve plant yield. In one example, applying the composition is sufficient to cumulatively release less than 70% of the biostimulant after 50 hours in a soil with a pH between 6 and 7. For example, applying the composition may be sufficient to cumulatively release less than 60% of the biostimulant after 50 hours in a soil with a pH between 6 and 7. For example, after 100 hours and at pH 7, the biostimulant may have a cumulative release of about 60%. After 100 hours and at pH 6, the biostimulant may have a cumulative release of about 90%.

In one example, applying the composition is sufficient to improve the overall plant yield. For example, applying the composition may enhance the overall yield of a plant by more than 20%, more than 30%, or more than 40%. The overall plant yield may be in terms of the final weight of the plant or biomass or the final height of the plant. In another example, applying the composition is sufficient to increase the average total fruit number. For example, applying the composition is sufficient to increase the average total fruit number by 1.5×, by 1.75×, or by 2×.

In one example, applying the composition is sufficient to increase zinc content in the plant fruit. For example, applying the composition may increase the fruit zinc content by two-fold or more. In another example, applying the composition is sufficient to improve a nutritional factor in a fruit. Importantly, the composition can deliver minerals that act as human micronutrients. For example, applying the composition can increase the iron, zinc, and/or copper content to improve the nutritional value of crops for humans. One or more nutrients in the plant fruit may be at least doubled in nutritional value by applying the composition during plant growth. Further, a treated plant can have biostimulant-free fruit-making the fruit safe for human consumption.

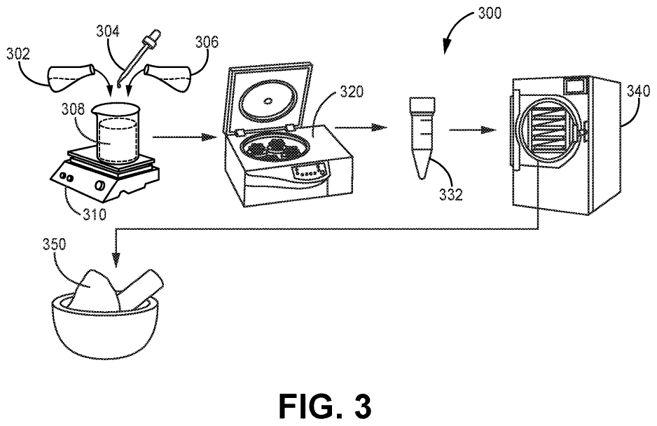

FIG. 3 illustrates a method 300 of synthesizing nanoparticles, according to some embodiments. Method 300 includes a first component 302, a second component 304, a third component 306, a mixture 308, a stirring device 310, a centrifuge 320, separated component 332, drying device 340, and powder 350. The first component 302, second component 304, and third component 306 may be contacted simultaneously or stepwise in any order to form mixture 308. For example, the first component 302, second component 304, and third component 306 may be poured while mixture 308 is being stirred by the stirring device 310. The mixture 308 can be in the form of a solution. Mixture 308 is separated in the centrifuge 320 sufficient to form the separated component 332. This step may further include washing one or more times. Next, the separated component may be placed in the drying device 340. The drying device 340 may include a vacuum assisted drying device. The drying device 340 may be sufficient to form pellets. The drying device 340 may be sufficient to reduce the pressure and humidity in a vessel and may include a heating element. These pellets may be ground into the powder 350.

The first component 302 may include one or more of an imidazole and a polyphenol. For example, the first component may include 2-methylimidazole. The second component 304 may include a metal salt such as a metal salt including one or more of calcium, iron, magnesium, and zinc. The second component 304 may include a nitrate salt. For example, the second component 304 may include zinc nitrate hexahydrate. The third component 306 may include one or more of a biostimulant, plant nutrient, and phosphate. In one example, the biostimulant is an apocarotenoid. For example, the biostimulant may be a cleavage product of carotenoids. The biostimulant may be a natural or synthetic apocarotenoid. In another example, the biostimulant includes natural and/or synthetic Zaxinone. For example, the synthetic (or mimic) Zaxinone may include one or more of MiZax-1, MiZax-2, MiZax-3, MiZax-4, and MiZax-5.

In one example, the centrifuge 320 may be operated at 2000-8000 RPM. In another example, the centrifuge 320 may be operated at 7000 RPM. The solution may be washed one or more times with water. The separation process may be sufficient to recover pellets. Other separation devices may be used in place of centrifuge 320. Drying device 340 may be operated under vacuum sufficient to dry the recovered pellets present in separated component 332. Drying device 340 may prepare the recovered pellets for grinding. The recovered pellets may be ground to the powder 350. The recovered pellets may be a solid in the form of any shape. For example, the recovered pellets may be substantially spherical or cylindrical. The recovered pellets may be any shape sufficient to include nanoparticles.

The powder 350 may include a plurality of nanoparticles. In one example, the nanoparticles have a diameter ranging from about 20 nm to about 300 nm. In another example, the nanoparticles have a diameter ranging from about 80 nm to about 200 nm. In yet another example, the nanoparticles have a diameter ranging from about 100 nm to 150 nm. The nanoparticles may be octahedral nanoparticles. The powder 350 may include a biostimulant encapsulated in a coordination-based platform. For example, the coordination-based platform may include a zeolitic imidazolate framework. The framework may have a hexagonal structure. The powder 350 may be added to other solids or liquids for delivery. For example, the powder may be added to soil or a liquid carrier for delivery to a plant. A powder may include fine, dry particles produced from grinding or crushing the pellets/particles. A powder may include fine particles that may freely flow when moved. Any process or method may be utilized to form a powder from pellets.

Importantly, the coordination-based platform composition of the present disclosure effectively improves plant yields. Encapsulating the biostimulant in the coordination-based platform improves stability of the biostimulant and decreases the rate of degradation by the environment. Applying the composition to a plant is sufficient to increase the zinc content in the plant fruit and improve a nutritional factor in the fruit. Further, a treated plant can have biostimulant-free fruit—making the fruit safe for human consumption.

### Example 1

Zaxinone mimics may be synthesized with the Wittig Reaction. In a round-bottomed flask, the mixture of dimethylformamide (2.0 mL), aldehyde (1.0 mmol) and (acetylmethylene)triphenylphosphorane (4.0 mmol) was stirred for 2 hours at 80° C., then ethyl acetate (15 mL) was added to the reaction mixture, which was washed with water and brine. The organic layer was dried over anhydrous sodium sulfate and concentrated under reduced pressure, then purified by column chromatography on silica gel, in which a mixture of hexane-ethylacetate was used as an eluent. This reaction may be utilized with the Suzuki-Miyaura Cross-Coupling procedure.

Zaxinone mimics may be synthesized by utilizing Suzuki-Miyaura Cross-Coupling. In a round-bottomed flask, the mixture of aryl bromide (2.0 mmol), boronic acid (1.0 mmol), THF (15.0 mL), 2N Na₂CO₃ (4.5 mL) and tetrakis(triphenylphosphine) palladium (0) (0.01 mmol) were refluxed overnight with stirring, then THF was removed under reduced pressure. The resultant mixture was solved into ethyl acetate (15 mL), which was washed with water and brine. The organic layer was dried over anhydrous sodium sulfate and concentrated under reduced pressure, then purified by column chromatography on silica gel, in which a mixture of hexane-ethyl acetate was used as an eluent.

Zaxinone mimics may be synthesized by an alternative procedure. In a round-bottomed flask, 1M boron tribromide in CH₂Cl₂ was added to the solution of methoxy-substituted aryl derivatives (1.0 mmol) in dichloromethane (5.0 mL) at 0° C. and stirred for 1 hour, then quenched with water (10 mL), diluted with CH₂Cl₂ (10 mL), and washed with brine. The organic layer was dried over anhydrous sodium sulfate and concentrated under reduced pressure, then purified by column chromatography on silica gel, in which a mixture of hexane-ethyl acetate was used as an eluent. This procedure may be utilized with the Wittig Reaction procedure. Zaxinone is shown below as an example.

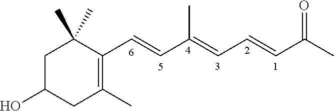

3-Formylbenzeneboronic acid and 4-bromophenol were used as starting materials of a Suzuki-Miyaura Cross-Coupling procedure, and the obtained compound was subjected to the Wittig Reaction to give MiZax-1 (shown below) with a 47% yield.

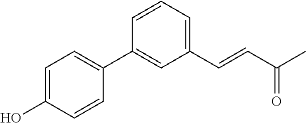 [SMILES: CC(=O)/C=C/c1cccc(-c2ccc(O)cc2)c1]

3-(4-Methoxyphenoxy)benzaldehyde was used as a starting material and the obtained compound was subjected to the Wittig Reaction to give MiZax-2 (shown below) with a 44% yield. MiZax-2 may also be referred to as (E)-4-(3-(4-hydroxyphenoxy)phenyl) but-3-en-2-one

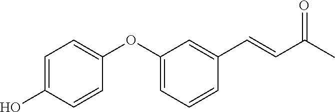 [SMILES: CC(=O)/C=C/c1cccc(Oc2ccc(O)cc2)c1]

3-(4-Methoxyphenoxy)benzaldehyde was used as a starting material in the Wittig Reaction to give MiZax-3 (shown below) with an 81% yield. MiZax-3 may also be referred to as (E)-4-(3-(4-methoxyphenoxy)phenyl) but-3-en-2-one

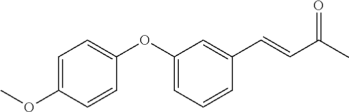 [SMILES: COc1ccc(Oc2cccc(/C=C/C(C)=O)c2)cc1]

1,3-Dibromobenzene was used as a starting material of a Suzuki-Miyaura Cross-Coupling procedure, in which 4-hydroxyphenylboronic acid and 3-acetylphenylboronic acid were sequentially subjected to the cross coupling to give MZ5, which was used to give MiZax-4 (shown below) with an 11% yield. MiZax-4 may also be referred to as 1-(4″-hydroxy-[1,1′:3′,1″-terphenyl]-3-yl)ethan-1-one

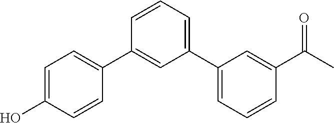 [SMILES: CC(=O)c1cccc(-c2cccc(-c3ccc(O)cc3)c2)c1]

1,3-Dibromobenzene was used as a starting material of a Suzuki-Miyaura Cross-Coupling procedure, in which 4-hydroxyphenylboronic acid and 3-acetylphenylboronic acid were sequentially subjected to the cross coupling to give MiZax-5 (shown below) with a 75% yield. MiZax-5 may also be referred to as 1-(4″-methoxy-[1,1′:3′,1″-terphenyl]-3-yl)ethan-1-one.

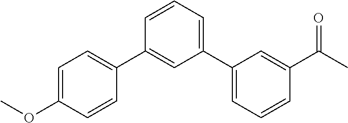 [SMILES: COc1ccc(-c2cccc(-c3cccc(C(C)=O)c3)c2)cc1]

### Example 2

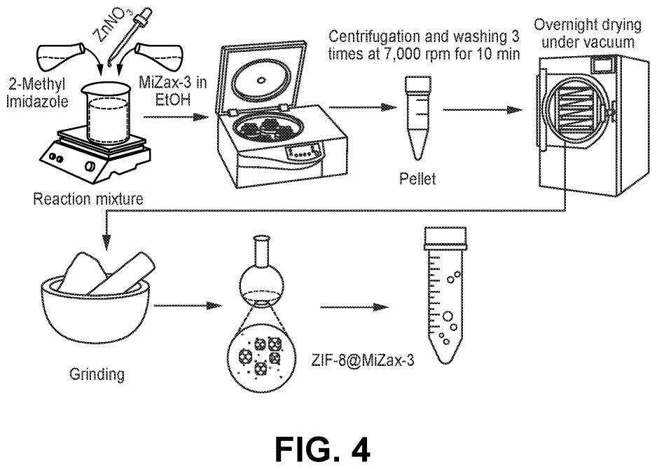

FIG. 4 illustrates a schematic illustration of a “one-pot” synthesis of the ZIF-8@MiZax-3 complex, according to some embodiments. All chemicals used were analytical reagent grade from commercial sources and used without further purification. 2-Methyl imidazole (99% purity) and zinc nitrate hexahydrate Zn(NO₃)₂·6H₂O (98% purity) were utilized. Phosphate-buffered saline (PBS) solution was also utilized.

An in situ encapsulation technique was used to prepare ZIF-8@MiZax-3. First, stock solutions of 20 mL of Zn(NO₃)₂ and 2-MIm were prepared at 0.5 M and 2.5 M concentrations respectively and diluted in purified MilliQ water. Another stock solution of 10 mL at 37.3 mM of MiZax-3 in ethanol was also prepared. Subsequently, 1.8 mL of 2-MIm and 100 μL of MiZax-3 from the stock solutions were mixed and kept under stirring at room temperature for 5 minutes. Subsequently, 0.2 mL of Zn(NO₃)₂·6H₂O were added dropwise to the previous mixture and stirred for 30 minutes at room temperature. The solution was centrifuged and washed three times with water at 7,000 rpm for 10 minutes. The recovered pellets were dried in a vacuum desiccator and ground to obtain a fine powder for further characterization analysis.

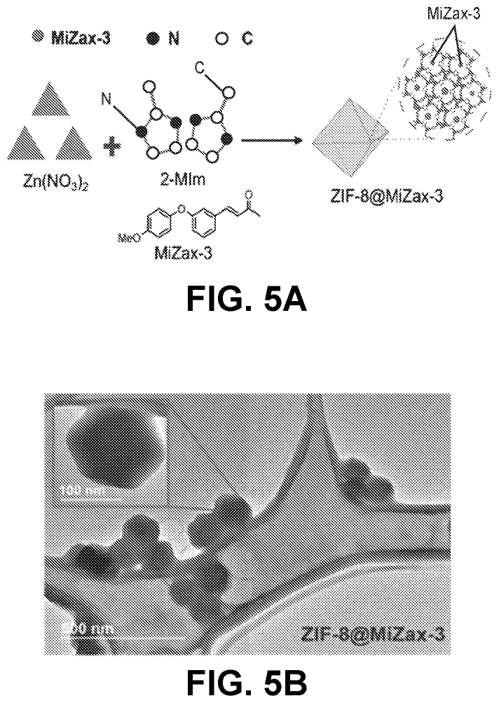

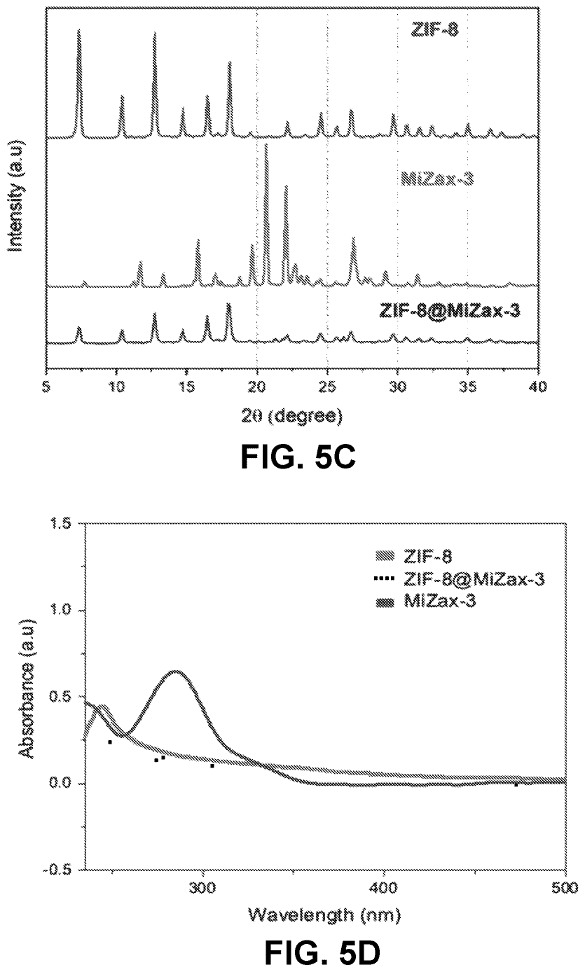

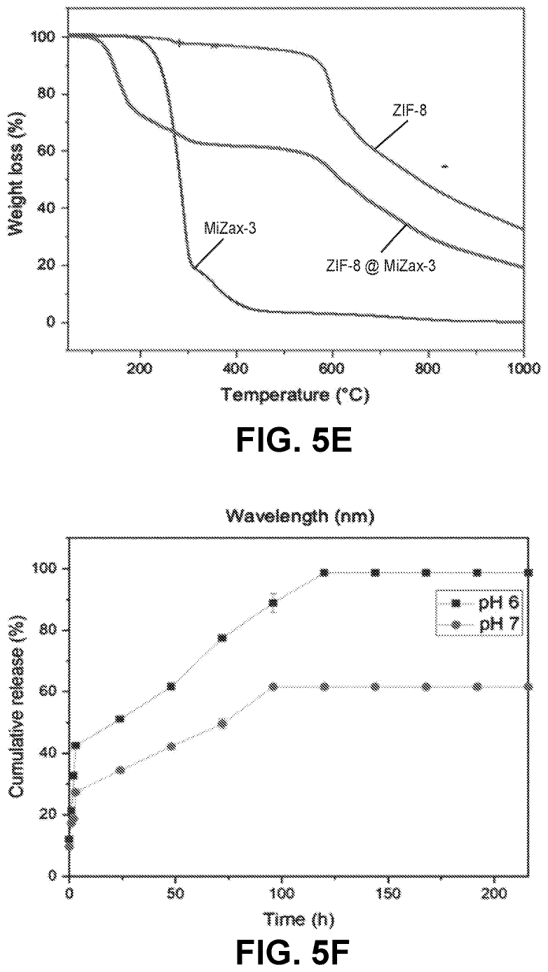

FIG. 5A illustrates a schematic representation of ZIF-8@MiZax-3 synthesis, according to some embodiments. Zinc nitrate hexahydrate, 2-methylimidazole, and MiZax-3 were utilized to form ZIF-8@MiZax-3. FIG. 5A shows that the ZIF-8 coordination-based platform encapsulates MiZax-3.

FIG. 5B illustrates a transmission electron microscopy (TEM) image of ZIF-8@MiZax-3 at 500 and 100 nm scales showing the hexagonal structure of the framework, according to some embodiments. TEM imaging was performed at 120 kV, in the bright-field mode to evaluate the morphology of the synthesized framework ZIF-8@MiZax-3. The TEM revealed uniformly dispersed octahedral nanoparticles, which is reminiscent of ZIF-8.

FIG. 5C illustrates PXRD patterns of ZIF-8, MiZax-3, and the synthesized ZIF-8@MiZax-3, according to some embodiments. The PXRD patterns of the as synthesized ZIF-8 displayed the successful preparation of ZIF-8 compared to the simulated one. Furthermore, the loading of MiZax-3 did not affect the crystallinity and phase purity of the final ZIF-8@MiZax-3 complex.

FIG. 5D illustrates a comparison of the UV-vis absorption spectra of ZIF-8, MiZax-3, and the synthesized ZIF-8@MiZax-3, according to some embodiments. The UV-vis analysis showed that the ZIF-8@MiZax-3 absorption was approximately at 243 nm and 283 nm, which is attributed to the absorption band of 2-methylimidazole depicted around 244 nm, whereas the characteristic absorbance of MiZax-3 alone was around 283 nm.

FIG. 5E illustrates thermo-gravimetric analysis (TGA) of ZIF-8, MiZax-3, and ZIF-8@MiZax-3 powder under N₂, according to some embodiments. Thermal stability was measured by using a TGA device and sample containers (Platinum HT pans). The sample containers were heated in N₂ flow up to 1000° C. with a heating rate of 10° C./min. Thermogravimetric analysis supported the stability of the system with a weight loss of 36.68% at 432° C. A slight weight loss (˜2.3%) displayed at the first stage below 200° C. is attributed to solvent evaporation.

FIG. 5F illustrates a cumulative release of MiZax-3 from the platform at acidic (pH 6) and neutral (pH 7) conditions, according to some embodiments. ZIF-8@MiZax-3 was incubated by dispersing 1 mg of ZIF-8@MiZax-3 in 1 mL PBS solution at pH 6 and 7, respectively. The solutions were collected in Eppendorf tubes and shaken for 20 minutes at 36° C. and 300 rpm. Upon completion, the samples were centrifuged at 14,800 rcf for 20 minutes at room temperature. The recovered supernatants were taken for analysis and replaced with the same amount of fresh PBS. To measure the concentration of the released MiZax-3 from ZIF-8, at different time intervals, 1 mL of CHCl₃ was added to each supernatant solution to recover the organic phase containing MiZax-3. These solutions were analyzed by UV-vis spectroscopy in triplicate at 283 nm wavelength. Briefly, aliquots of 6 μL were taken from the supernatant at 0, 1, 2, 3, 24, 48, 72, 96, 120, 144, 168, 192, and 216 hours. As expected, the release rate of ZIF-8@MiZax-3 at pH 6.0 was higher than that at pH 7.0. It was observed that after 3 hours, 27.3% of MiZax-3 was released from the ZIF-8@MiZax-3 solution at pH 7.0, whereas 42.5% was released at the same time point in the ZIF-8@MiZax-3 solution at pH 6.0. The percentage release (% R) at each time point was performed using the following equations:

$${Amount}_{n} = ( Concentration of MiZax - 3 ) in supernatant ( \frac{μ g}{μ L} ) \times volume ( μL ) \qquad ( 1 )$$

$$\% R = \frac{{Amount}_{n} - {Amount}_{n - 1}}{Total amount of encapsulated MiZax - 3} \times 100 \qquad ( 2 )$$

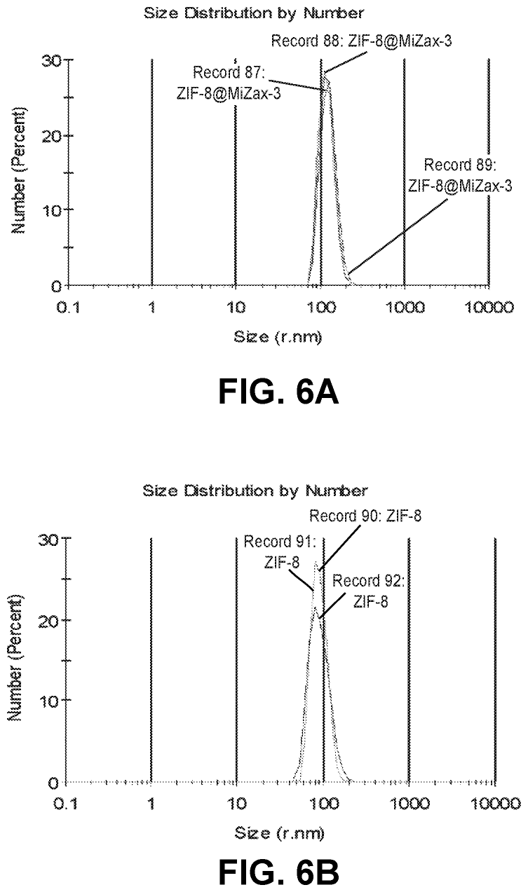

FIG. 6A illustrates the particle size distribution of the ZIF-8@MiZax-3 complex, according to some embodiments. FIG. 6B illustrates the particle size distribution of the ZIF-8 complex, according to some embodiments. To obtain the particle size and polydispersity index (PdI), 1 mg of ZIF-8@Mizax-3 and ZIF-8 was diluted in 1 mL of MilliQ water, respectively. Then, the mixtures were dispersed by bath sonication for 10 minutes at room temperature. After sonication, the samples were placed on a glass cuvette and scanned at 25° C. and 60 second intervals in triplicate. For measurements of the ζ-potential, the samples were diluted in MilliQ water solution and transferred to a Universal Dip Cell. Dynamic light scattering studies of ZIF-8@MiZax-3 showed a uniform particle size of 130.13±3.1 nm with a zeta potential (¿) of ±16.86 mV±0.66 (compared to ±25.9±0.9 (mV) for ZIF-8). Table 1 shows the particle size, distribution and ζ-potential of ZIF-8 and ZIF-8@MiZax-3 complex.

TABLE 1
Particle size, distribution and ζ-potential
of ZIF-8 and ZIF-8@MiZax-3 complex.

| Sample Name | Particle size (nm) | Pdl | Zeta potential (mV) |
|---|---|---|---|
| ZIF-8@MiZax-3 | 130.13 ± 3.1 | 0.039 ± 0.05 | +16.86 ± 0.66 |
| ZIF-8 | 113.36 ± 6.03 | 0.275 ± 0.08 | +25.9 ± 0.9 |

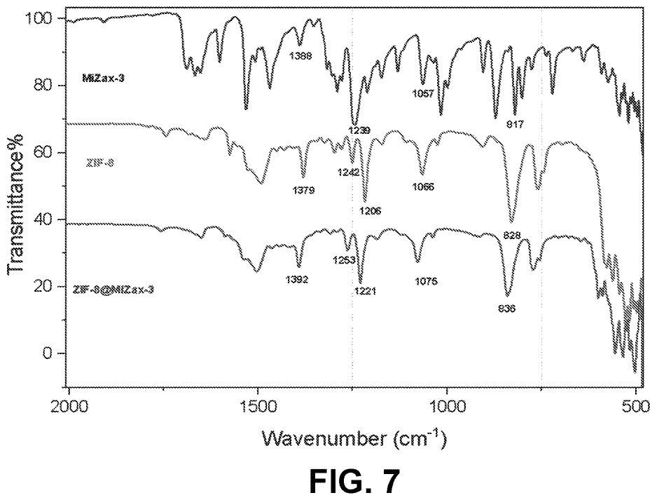

FIG. 7 illustrates a comparison of the FTIR spectra of MiZax-3, ZIF-8, and ZIF-8@MiZax-3, according to some embodiments. Chemical composition and identification of functional groups were characterized by using Fourier transform infrared spectroscopy with attenuated total reflection mode and reported in transmittance units for the as-synthesized ZIF-8@MiZax-3 and compared with the ZIF-8 and MiZax-3 spectrum. The FTIR analysis revealed the characteristic peaks of ZIF-8@MiZax-3, including the peaks at 1675 cm⁻¹ and 1505 cm⁻¹ that are attributed to the C═N bending in addition to the bands at 1421 cm⁻¹ and 1310 cm⁻¹, corresponding to the stretching of the whole imidazole ring. The representative peaks were present in both systems, which confirms the incorporation of MiZax-3 with ZIF-8.

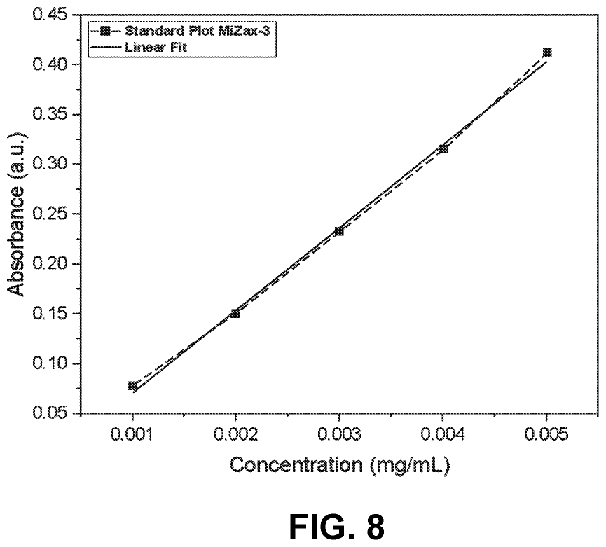

FIG. 8 illustrates the standard plot of MiZax-3 solution in chloroform at different concentrations, according to some embodiments. Determination of encapsulation efficiency (EE %) and loading capacity (LC %) were determined by using a UV-Vis Spectrophotometer at 283 nm absorbance. A calibration curve of MiZax-3 in chloroform was done at different concentrations (0.001, 0.002, 0.003, 0.004, and 0.005 mg/mL) and the percentages were obtained with equations 3 and 4 below.

$$EE \% = \frac{Mass of loaded MiZax - 3}{Initial mass o f MiZax - 3} \times 100 \qquad ( 3 )$$

$$LC \% = \frac{Mass of loaded MiZax - 3}{Mass of ZIF - 8 @ MiZax - 3} \times 100 \qquad ( 4 )$$

Where Initial Mass of MiZax-3=weight of initial MiZax-3 used in the formulation (mg), Mass of loaded MiZax-3=weight of MiZax-3 loaded in the framework (mg), and Mass of ZIF-8@MiZax-3=total weight of the complex (mg). The loading efficiency of ZIF-8@MiZax-3 was calculated to be 62% based on Equations 1 and 2. The linear fit is Y=83.3X−0.0133 with an R² value of 0.9973.

Soil temperature and water content are directly associated with the degradation and loss of fertilizers, hormones and other materials that are used for crop fortification. Thus, encapsulation or intercalation within a protective/coordination framework, such as ZIFs, improves stability for large-scale and/or long-lasting field experiments. The thermal stability of ZIF-8@MiZax-3 was examined versus MiZax-3 under varied conditions by mimicking the real-life field environment to test the impact of encapsulation.

Organic matter is combined with more than 90% of the nitrogen sources present in the soil, with 20%-40% of this ratio in amino form. The amino acid (AA) composition of soil organic matter depends on several factors, for instance, pH, plant interaction with other microorganisms, environmental factors (e.g., temperature and CO2 levels), and chemical and nutrient composition. Thus, considering the complexity of using soil as substrates for plants as well as the mechanisms that these undergo during their growth stages, it is important to develop more resistant materials that remain stable under certain conditions. To test the stability of ZIF-8@MiZax-3, it was dissolved in a series of AA media and incubated it at 45° C. for 24 hours. Additionally, PBS and HEPES solutions were utilized to assess the thermal stability in biological and physiological conditions.

A set of samples were prepared as follows: Aspartic acid (5 mM), Glutamine (5 mM), Histidine (5 mM), PBS (1×), Asparagine (5 mM), Glutamic acid (5 mM), Alanine (5 mM), HEPES (10 mM), Mixture of amino acids (5 mM) all in 5 mL of PBS and 1 drop of ethanol. Subsequently, the samples were vortexed for 10 seconds and incubated at 45° C. for 24 hours. Finally, the samples were subjected to centrifugation, and the recovered pellets were dried under a vacuum to eliminate any traces of water. To determine if the thermal treatment had an effect on the samples, the pellets were dissolved in chloroform and analyzed in a UV-vis spectrophotometer at 283 nm.

The thermal stability of compounds was examined after incubating the dry materials in microtubes for a month at 45° C. by considering high field temperatures. After incubation, the framework was broken in an acidic solution (pH: 1.0, 1M HCl in dioxane mixed with tetrahydrofuran (THF)) to liberate the MiZax-3 from the ZIF-8@MiZax-3 complex. The released MiZax-3 was collected by evaporating THF and dioxane, respectively, under the steam of N₂ and resuspended in CHCl₃:H₂O mixture (1:1, v/v) and separated by centrifugation. The collected upper phase with MiZax-3 was then evaporated and finally dissolved in 100% LC-MS-grade acetonitrile for proceeding with the LC-MS analysis for the quantification of remaining bioactive MiZax-3.

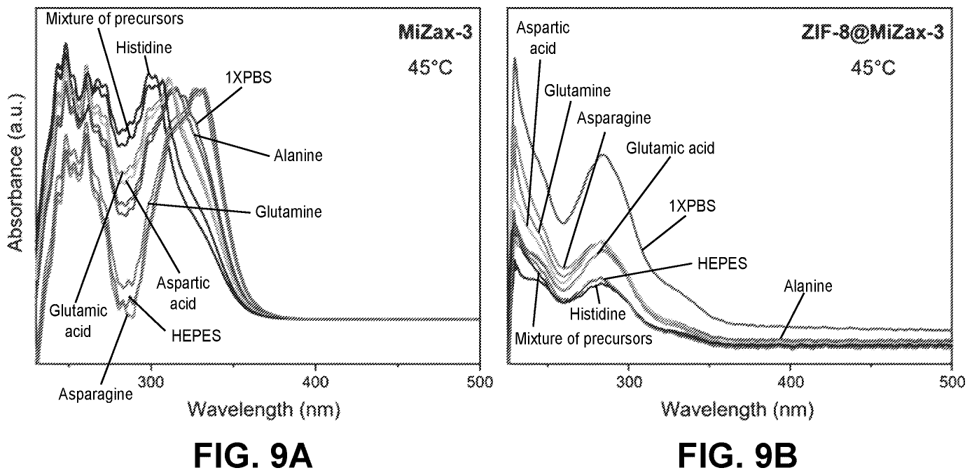

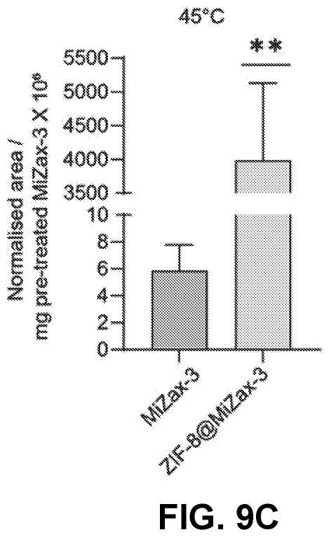

FIG. 9A illustrates UV-vis spectra demonstrating the thermal stability of MiZax-3 in aqueous solutions prepared with several components of the soil organic matter after 24 hours of treatment at 45° C., according to some embodiments. FIG. 9B illustrates UV-vis spectra demonstrating the thermal stability of ZIF-8@MiZax-3 in aqueous solutions prepared with several components of the soil organic matter after 24 hours of treatment at 45° C., according to some embodiments. A decrease in intensity around 283 nm wavelength and remarkable shifts in the absorbance maxima of MiZax-3 were readily observed after the incubation period. The presence of amino acids such as glutamine can lead to changes in UV-vis spectra due to surface interactions between particles and amino acid molecules. The absorption bands of MiZax-3 exhibited significant wavelength shifts up to 332 nm in all AA and buffer solutions after thermal incubation. No major shifts were observed in ZIF-8@MiZax-3 UV-Vis spectrum after thermal treatment, neither in AA nor in the two buffer solutions. Therefore, the use of ZIF-8 as a packaging platform confers thermal stability of the dissolved MiZax-3 and prevents structural changes of the loaded bioactive molecules.

FIG. 9C illustrates LC-MS quantification of the remaining MiZax-3 in dry powder form after incubation at 45° C. for 30 days, according to some embodiments. The LC-MS analysis indicated that the ZIF-8 encapsulation could significantly enhance the MiZax-3 stability up to around 679 times (p-value=0.0072). This indicated that the packaged MiZax-3 largely maintains its stability upon storage and usage in a field environment with high temperatures. The increased stability of encapsulated MiZax-3 may substantially increase the efficiency of utilizing this biostimulant by crops, compared to the application without formulation.

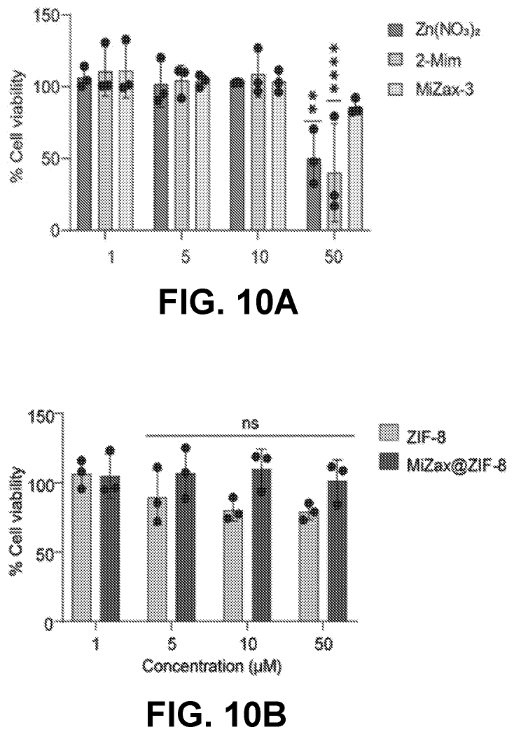

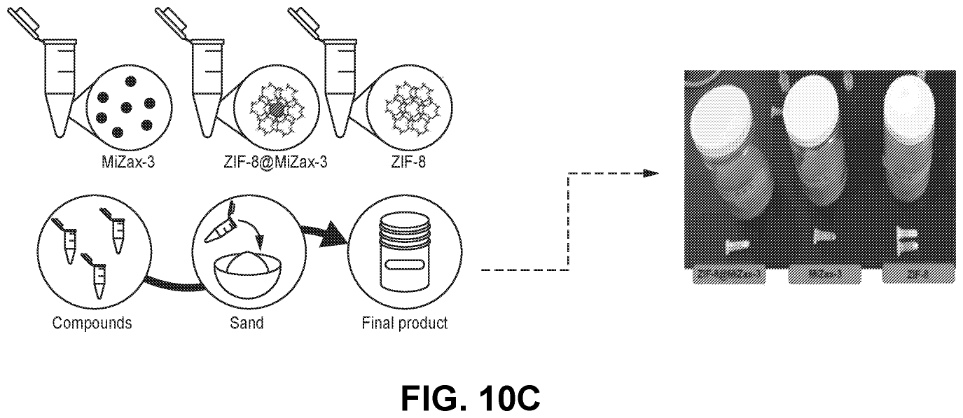

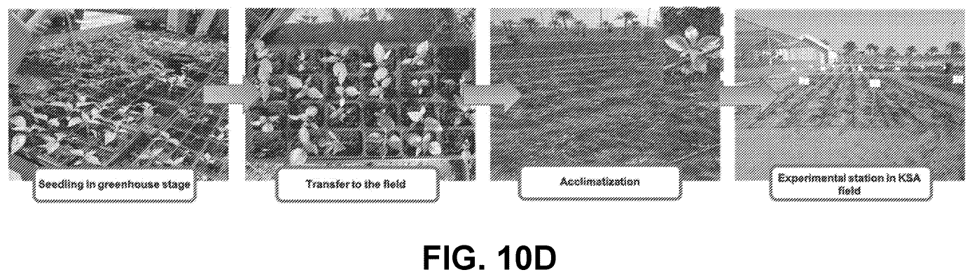

FIG. 10A illustrates a cytotoxicity analysis of precursor molecules, including Zn(NO₃)₂, 2-MIm, and MiZax-3, according to some embodiments. FIG. 10B illustrates a cytotoxicity analysis of ZIF-8 and ZIF-8@MiZax-3 complexes, according to some embodiments. Assessing the safety of this synthetic platform is critical. Accordingly, it is important to check if any of the materials or degraded building blocks are transferred from the rhizosphere to the actual fruit. For cytotoxicity analysis, live-dead viability and cell counting kit-8 (CCK-8) assays were performed according to the manufacturer's protocol. Briefly, 3T3 cells (1×10⁴ cells per well) were seeded onto a 96-well plate. After 24 hours, cells were incubated with different concentrations (0.1, 0.5, 1, 5, 10, and 50 μg/mL) of ZIF-8 and ZIF-8 loaded with MiZax-3. In addition, to evaluate the cytotoxicity of the particles after degradation at low pH, 3T3 cells were incubated with Zn(NO₃)₂ and 2-MIm at concentrations of (0.01, 0.05, 0.1, 0.5, 1, 5, 10, and 50 μg/mL) and with MiZax-3 at (0.01, 0.05, 0.1, 0.5, 1, 5, 10, and 50 ng/mL). The cell viability was measured after 24 hours. The precursors exhibited high biocompatibility up to 10 μg/mL for Zn(NO₃)₂, 2-MIm, and up to 50 ng/ml in the case of MiZax-3. Most importantly, the LC-MS analysis of pepper fruits produced by plants treated with MiZax-3 or ZIF-8@MiZax-3 in the field trial had no detectible MiZax-3, indicating the safety of MiZax-3 as a biostimulant.

FIG. 10C illustrates a schematic representation of the final product utilized for soil treatment, according to some embodiments. The final products included ZIF-8, MiZax-3, and ZIF-8@MiZax-3. These products were added to the sand/soil for the field experiment. FIG. 10D illustrates pictures of a field experiment utilizing ZIF-8@MiZax-3, according to some embodiments. Capsicum (C. annuum L. var. California Wonder) seedlings used for the field trial were initially germinated in soil and grown until the 4-week-old stage in a greenhouse under a semi-controlled environment adjusted to 28° C. (day)/26° C. (night) temperature, under 12 hours-light photoperiod with 60% humidity for nursery. During the nursery period, seedlings were given Hoagland solution to boost their growth before transferring to the field. The uniformly selected seedlings were transferred to the field during the winter season.

The field used for the capsicum trial for testing ZIF-8, MiZax-3, and ZIF-8@MiZax-3 was divided into plots and treatments were allocated by following randomized complete block design (RCBD) with three replications as previously described. Each plot size was around 2 m×1.2 m with a planting distance of 50 cm×60 cm (8 plants/plot). After a week of acclimation, the first soil treatments were completed by mixing ZIF-8 (˜33.3 mg/L soil), MiZax-3 (˜1.38 mg/L soil), and ZIF-8@MiZax-3 (˜33.3 mg/L soil) directly on top of each plant stem on the soil surface. The treatments were repeated twice with a month gap in between. Plants were watered with a drip irrigation system twice a day, with an average of half a liter of water per individual. Plant phenotyping data were collected until 13 weeks after transplanting (13WAT) stage to the field.

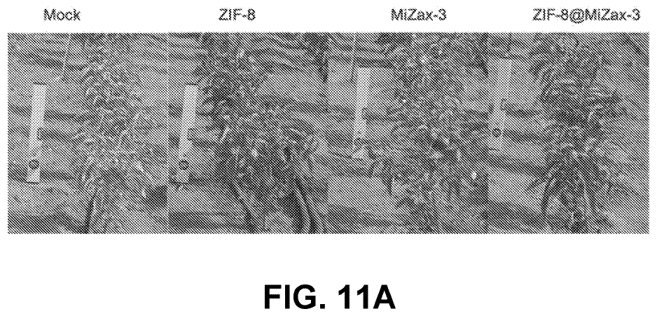

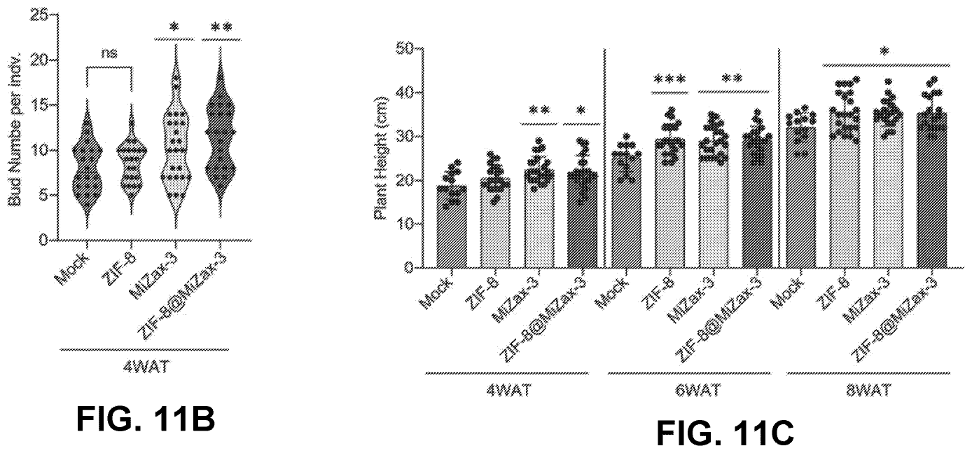

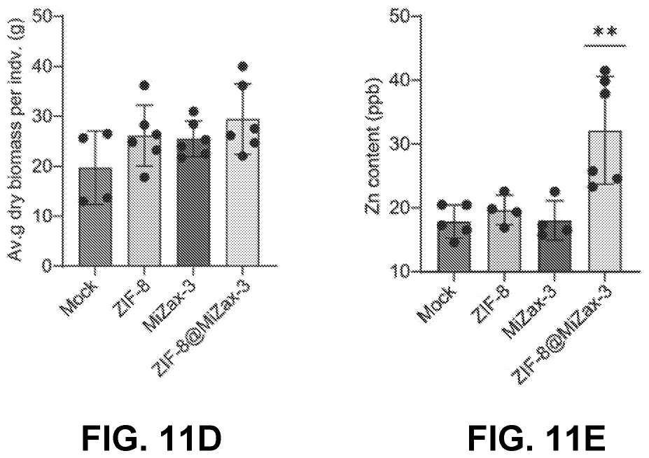

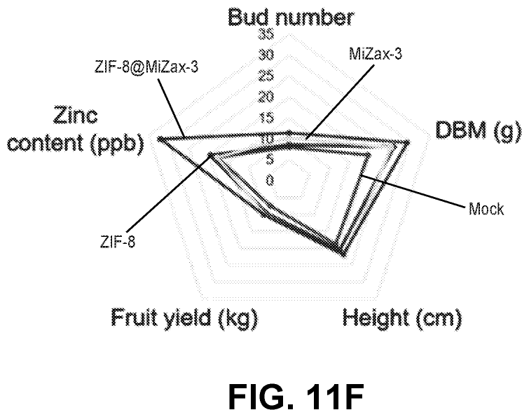

FIG. 11A illustrates representative images taken from capsicum field trials at the final stage of development (13WAT), according to some embodiments. In general, plants treated with MiZax-3 and ZIF-8@MiZax-3 were healthier than the mock plants at the final stage of their development (13WAT; 13 weeks after treatment). The unloaded ZIF-8 was utilized as a control. The plants with ZIF-8 treatment looked healthier than the mock plants, thus supporting the positive impact of the ZIF-8 framework on the plants.

FIG. 11B illustrates a graph of the number of buds per individual at 4WAT, according to some embodiments. Capsicum seedlings treated with MiZax-3 and ZIF-8@MiZax-3 had a significantly higher number of flower buds compared to the mock and ZIF-8 treated seedlings at the 4WAT stage. Two consecutive harvests were completed to compare the total fresh fruit yield harvested per total number of plants (n=24) between treatments and mock. The ZIF-8, MiZax-3 and ZIF-8@MiZax-3 treatments enhanced the total yield by 26.37%, 31.76% and 35.11%, respectively. Table 2 shows the average total fruit number, harvest amount in grams, the total yield in grams, and the yield enhancement. The zinc ions in the framework can contribute to the enhanced performance that was observed with plain ZIFs. In addition, zinc fertilizers can alter the microbial communities in the rhizosphere, which promotes plant growth and eventually increases yield.

TABLE 2
Yield-related parameters from capsicum field trial.

| Type | Mock | ZIF-8 | MiZax-3 | ZIF-8@MiZax-3 |
|---|---|---|---|---|
| Average Total | 27.50 | 48.33 | 53.17 | 53.17 |
| Fruit Number | | | | |
| Harvest-1 (g) | 3704.4 | 4391.5 | 4464.8 | 4843.3 |
| Harvest-2 (g) | 3800.5 | 5092.6 | 5423.8 | 5296.4 |
| Total Yield (g) | 7504.9 | 9484.1 | 9888.6 | 10139.7 |
| Yield | | 26.37 | 31.76 | 35.11 |
| Enhancement (%) | | | | |

FIG. 11C illustrates a graph of the plant height measurements recorded at 4WAT, 6WAT and 8WAT, according to some embodiments. At the 4WAT stage, the plants treated with MiZax-3 and/or ZIF-8@MiZax-3 were significantly taller than mock and ZIF-8 treated plants, whereas, at the 6WAT and 8WAT stages, all plants with treatments were significantly taller than mock.

FIG. 11D illustrates a graph of the average dry biomass of an individual plant per lane at 13WAT, according to some embodiments. There was no statistically significant difference observed in the average dry shoot biomass per individual plants harvested at 13WAT stage; however, there was an upwards trend with the plants treated with ZIF-8, MiZax-3 and ZIF-8@MiZax-3 compared to mock.

FIG. 11E illustrates a graph of the zinc content analysis of capsicum fruits across treatments, according to some embodiments. An ICP-MS analysis was performed to check if the ZIF-8 and/or ZIF-8@MiZax-3 treatments increased the capsicum fruit zinc content to confirm the role of the framework's zinc ions. Samples were previously digested by using a digestion system in 70% HNO₃ at 50° C. and 40 mbar for 1 hour. The solutions were further diluted for analysis to quantify zinc concentration in ppb. The accumulated zinc content in the crop fruits or grains and the efficiency of the root zinc absorption from the rhizosphere depends on the watering or precipitation regime, soil pH, availability of metal chelators and the efficiency of zinc transporter proteins and some other traits specific to crop species or the variety. Capsicum fruits treated with ZIF-8@MiZax-3 had 1.8-fold higher zinc content (p-value=0.0014) compared to all other treatments, thus indicating a positive impact of encapsulated MiZax-3 on the enhancement or transportation of zinc from the rhizosphere to the fruit, although the field trial experiments had relatively poor-quality soil. Control experiments with only ZIF-8 did not show any increase in the zinc content, which further supports the role of the encapsulated MiZax-3 in improving the zinc content. A higher amount of zinc was only observed in the fruits of plants treated with ZIF-8@MiZax-3.

FIG. 11F illustrates a spider-web diagram summarizing the findings in the capsicum field trial demonstrating the overall superiority of ZIF-8@MiZax-3 over other treatments and mock, according to some embodiments. ZIF-8@MiZax-3 could efficiently load MiZax-3 with a 62% loading efficiency while keeping the growth regulator stable for over 30 days at high temperatures and real-life field conditions. Importantly, the plants treated with ZIF-8@MiZax-3 showed close to a two-fold increase in fruit zinc content, which is very important for micronutrient fortification. This conclusively makes ZIF-8@MiZax-3 a superior formulation at promoting plant growth and development, compared to ZIF-8 and MiZax-3.

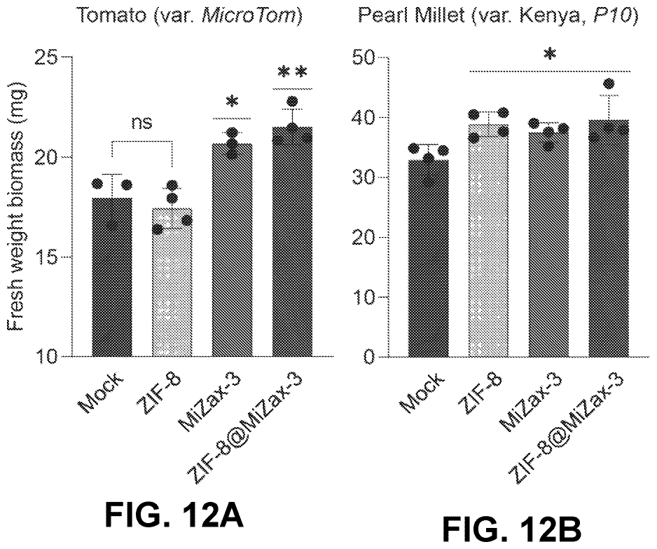

FIG. 12A illustrates fresh biomass analysis of tomato seedlings treated with ZIF-8, MiZax-3 (5 μM), ZIF-8@MiZax-3, according to some embodiments. FIG. 12B illustrates fresh biomass analysis of pearl millet seedlings treated with ZIF-8, MiZax-3 (5 μM), ZIF-8@MiZax-3, according to some embodiments. Treatments were performed by suspending the reagents in acetone prior to adding them to the Hoagland solution (pH: 5.8) composed of 5.6 mM NH₄NO₃, 0.8 mM MgSO₄·7H₂O, 0.8 mM K₂SO₄, 0.18 mM FeSO₄·7H₂O, 0.18 mM Na₂EDTA·2H₂O, 1.6 mM CaCl₂·2H₂O, 0.8 mM KNO₃, 0.023 mM H₃BO₃, 0.0045 mM MnCl₂·4H₂O, 0.0003 mM CuSO₄·5H₂O, 0.0015 mM ZnCl₂, 0.0001 mM Na₂MoO₄·2H₂O with 0.4 mM K₂HPO₄·2H₂O. The 5 mL Hoagland solution supplemented with ZIF-8 (˜33.3 mg/L)/MiZax-3 (5 μM)/ZIF-8@MiZax-3 (˜33.3 mg/L) per plate was used to grow the seedlings. For each treatment, four biological replicates, each with 25 seeds, were distributed uniformly on each plate. Seedlings were grown in a controlled plant growth chamber adjusted to 22° C., 16/8 hour day/night photoperiod (120-150 μE m⁻² s⁻¹) and 60% humidity. Seedlings were collected 7 days after the germination (7DAG) stage and gently wiped to remove the excess water prior to recording the fresh weight biomass.

It was examined if the newly developed ZIF-8@MiZax-3 formulation could improve plant growth in a relatively small-scale experiment by treating tomato (var. MicroTom) and pearl millet (var. Kenya, P10) seedlings in petri plates until 7 days after germination (7DAG). In tomato, ZIF-8@MiZax-3 enhanced the plant's fresh weight of tomato plants when grown in hydroponic media (Hoagland solution, pH: 5.8, 5 μM MiZax-3). The observed positive effect was at least comparable to that of treatment with MiZax-3 alone, indicating that the ZIF-8@MiZax-3 complex can effectively release the bioactive MiZax-3, which promotes plant growth at the early seedling stage. Similar data was obtained for the pearl millet where ZIF-8@MiZax-3 enhanced the fresh seedling biomass at the 7DAG stage.

### Discussion of Possible Embodiments

A plant treatment composition includes a biostimulant and a coordination-based platform including a metal, wherein the biostimulant is encapsulated in the coordination-based platform and the metal interacts with the biostimulant.

The plant treatment composition of the preceding paragraph can optionally include, additionally and/or alternatively any one or more of the following features, configurations and/or additional components.

The biostimulant may include Zaxinone.

The Zaxinone may include a synthetic Zaxinone including one or more of MiZax-1, MiZax-2, MiZax-3, MiZax-4, and MiZax-5.

The coordination-based platform may include a zeolitic imidazolate framework (ZIF).

The metal may include one or more of calcium, iron, magnesium, and zinc.

The plant treatment composition may further include phosphorous.

The plant treatment composition may include a plurality of nanoparticles ranging from 50 nm to 150 nm.

A method of synthesizing nanoparticles includes contacting one or more of an imidazole and a polyphenol with a biostimulant to form a first solution; contacting the first solution with a metal salt sufficient to form a second solution; and separating the second solution sufficient to obtain formed nanoparticles, wherein the formed nanoparticles include the biostimulant encapsulated in a coordination-based platform.

The method of the preceding paragraph can optionally include, additionally and/or alternatively any one or more of the following features, configurations and/or additional components.

The imidazole may include 2-methylimidazole and the biostimulant may include Zaxinone.

The Zaxinone may include synthetic Zaxinone including one or more of MiZax-1, MiZax-2, MiZax-3, MiZax-4, and MiZax-5.

The metal salt may include one or more of calcium, iron, magnesium, and zinc.

The formed nanoparticles may include a plurality of nanoparticles ranging from 50 nm to 150 nm.

The coordination-based platform may include a zeolitic imidazolate framework (ZIF).

A method of promoting plant growth includes applying to a seed, plant propagation material, or plant, a composition including a biostimulant, and a coordination-based platform, wherein the biostimulant is encapsulated in the coordination-based platform and the composition is sufficient to improve plant yield.

The method of the preceding paragraph can optionally include, additionally and/or alternatively any one or more of the following features, configurations and/or additional components.

The biostimulant may include Zaxinone.

The Zaxinone may include a synthetic Zaxinone including one or more of MiZax-1, MiZax-2, MiZax-3, MiZax-4, and MiZax-5.

The coordination-based platform may include a zeolitic imidazolate framework (ZIF) and a metal, and wherein the metal may interact with the biostimulant sufficient to increase the plant yield.

The metal may include one or more of calcium, copper, iron, magnesium, and zinc.

Applying the composition may be sufficient to increase zinc content of the plant.

Applying the composition may be sufficient to improve a nutritional factor in a fruit.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

What is claimed is:

1. A plant treatment composition, the composition comprising:
a biostimulant; and
a coordination-based platform including a metal,
wherein the biostimulant is encapsulated in the coordination-based platform and the metal interacts with the biostimulant.

2. The plant treatment composition of claim 1, wherein the biostimulant includes Zaxinone.

3. The plant treatment composition of claim 2, wherein the Zaxinone includes a synthetic Zaxinone including one or more of MiZax-1, MiZax-2, MiZax-3, MiZax-4, and MiZax-5.

4. The plant treatment composition of claim 1, wherein the coordination-based platform includes a zeolitic imidazolate framework (ZIF).

5. The plant treatment composition of claim 1, wherein the metal includes one or more of calcium, iron, magnesium, and zinc.

6. The plant treatment composition of claim 1 further comprising phosphorous.

7. The plant treatment composition of claim 1, wherein the plant treatment composition includes a plurality of nanoparticles ranging from 50 nm to 150 nm.

8. A method of synthesizing nanoparticles, the method comprising:
contacting one or more of an imidazole and a polyphenol with a biostimulant to form a first solution;
contacting the first solution with a metal salt sufficient to form a second solution; and
separating the second solution sufficient to obtain formed nanoparticles,
wherein the formed nanoparticles include the biostimulant encapsulated in a coordination-based platform.

9. The method of claim 8, wherein the imidazole includes 2-methylimidazole and the biostimulant includes Zaxinone.

10. The method of claim 9, wherein the Zaxinone includes synthetic Zaxinone including one or more of MiZax-1, MiZax-2, MiZax-3, MiZax-4, and MiZax-5.

11. The method of claim 8, wherein the metal salt includes one or more of calcium, iron, magnesium, and zinc.

12. The method of claim 8, wherein the formed nanoparticles include a plurality of nanoparticles ranging from 50 nm to 150 nm.

13. The method of claim 8, wherein the coordination-based platform includes a zeolitic imidazolate framework (ZIF).

14. A method of promoting plant growth, the method comprising:
applying to a seed, plant propagation material, or plant, a composition including:
a biostimulant; and
a coordination-based platform,
wherein the biostimulant is encapsulated in the coordination-based platform and the composition is sufficient to improve plant yield.

15. The method of claim 14, wherein the biostimulant includes Zaxinone.

16. The method of claim 15, wherein the Zaxinone includes synthetic Zaxinone including one or more of MiZax-1, MiZax-2, MiZax-3, MiZax-4, and MiZax-5.

17. The method of claim 14, wherein the coordination-based platform includes a zeolitic imidazolate framework (ZIF) and a metal, and wherein the metal interacts with the biostimulant sufficient to increase the plant yield.

18. The method of claim 17, wherein the metal includes one or more of calcium, copper, iron, magnesium, and zinc.

19. The method of claim 14, wherein applying the composition is sufficient to increase zinc content of the plant.

20. The method of claim 14, wherein the applying the composition is sufficient to improve a nutritional factor in a fruit.
